(19) United States
(12) Patent Application Publication
(10) Pub. No.: US 2017/0225353 A1
(43) Pub. Date: Aug. 10, 2017

(54) QUICK CHANGE WOODWORKING SPADE BIT

(71) Applicant: Compass Corp., Tainan City (TW)

(72) Inventor: Tzu-Chien Wang, Tainan City (TW)

(21) Appl. No.: 15/040,919

(22) Filed: Feb. 10, 2016

(51) Int. Cl. B27G 15/00; B23B 51/00

(52) U.S. Cl. CPC B27G 15/00; B23B 51/0009; B23B 2251/02

(57) ABSTRACT

A quick change woodworking spade bit includes a bit having a cutting portion and an insertion portion with a positioning hole. A shank is coupled with a rear end of a connecting seat. The insertion portion of the bit is detachably engaged in an insertion hole in a front end of the connecting seat. First and second recessed portions are defined in a peripheral wall of the connecting seat. The second recessed portion includes first and through-holes intercommunicated with the first recessed portion and the insertion hole, respectively. An actuating rod is mounted in the second recessed portion and includes an engagement column extending through the first through-hole and a positioning column extending through the second through-hole. A button is mounted in the first recessed portion and is operably connected to the engagement column. The positioning column is biased by an elastic element to engage with the positioning hole.

### BACKGROUND OF THE INVENTION

The present invention relates to a quick change woodworking spade bit and, more particularly, to a woodworking tool spade bit capable of reducing the inventory, providing easy carriage, and reducing the replacement costs.

Wood materials generally have special grains, and woodworking spade bits are generally used to proceed with hole drilling operation of the wood materials. With reference to FIG. 7, a woodworking spade bit 1′ generally includes a shank 11′ and a bit portion 12′. The shank 11′ is lathed to provide a standardized polygonal shape for coupling with an external tool. The bit portion 12′ includes a main cutting portion 121′. A pointed guiding section 122′ protrudes from a center of a front end of the main cutting portion 121′. A side pointed portion 123′ is provided on the front end of each of two sides of the main cutting portion 121′. In the beginning of a drilling operation, the spade bit 1′ is rotated to drill a small hole in wood with the guiding section 122′ of the bit portion 12′. Then, the main cutting portion 121′ rotates into the wood to proceed with the drilling operation.

The diameter of the hole formed by the spade bit 1′ is equal to a width W′ of the main cutting portion 121′. When it is desired to drill holes of different diameters in the wood, a corresponding number of spade bits 1′ of different diameters is required, leading to an increase in the inventory and inconvenience to carriage.

Furthermore, the shank 1′ and the bit portion 12′ of the spade bit 1′ are made of the same material. The spade bit 1′ is often produced from a low hardness material (such as middle/low carbon steel) to reduce the costs, resulting in a low hardness at the bit portion 12′ which tends to wear after a period of time of use. The replacement costs are high, because the whole spade bit 1′ must be replaced.

### BRIEF SUMMARY OF THE INVENTION

An objective of the present invention is to provide a woodworking tool spade bit capable of reducing the inventory, providing easy carriage, and reducing the replacement costs.

A quick change woodworking spade bit according to the present invention includes a shank, a bit, and a connecting device. The shank can be coupled to an external tool. The bit includes two wide faces extending perpendicularly to a longitudinal direction and opposite to each other. The bit includes a front end having a cutting portion and an insertion portion spaced from the cutting portion in the longitudinal direction. The insertion portion includes a positioning hole having a central axis extending perpendicularly to the two wide faces and the longitudinal direction. The connecting device includes a connecting seat, an actuating rod, a button, and an elastic element. The connecting seat includes a front end, a rear end, and a peripheral wall extending between the front and rear ends of the connecting seat. The rear end includes a rear coupling portion. The front end of the shank is coupled with the rear coupling portion. The connecting seat further includes an insertion hole extending from the front end of the connecting seat in the longitudinal direction. The insertion portion of the bit is detachably engaged in the insertion hole of the connecting seat. First and second recessed portions are defined in an intermediate portion of the peripheral wall of the connecting seat and are diametrically opposite to each other. The second recessed portion includes a first through-hole intercommunicated with the first recessed portion. The second recessed portion further includes a second through-hole intercommunicated with the insertion hole. The actuating rod is mounted in the second recessed portion and includes an engagement column, a positioning column and a connecting portion interconnected between the engagement column and the positioning column. The engagement column extends through the first through-hole. The positioning column extends through the second through-hole. The button is mounted in the first recessed portion and is operably connected to the engagement column. The elastic element provides elasticity for operation of the button and the actuating rod. The positioning column is biased by the elastic element to engage with the positioning hole. When the button is pressed, the positioning column disengages from the positioning hole.

A rear end of the insertion portion of the bit can include an inclined guiding face inclining rearwards towards a central axis of the bit. The positioning column can include an inclined guiding surface inclining rearwards and upwards. The inclined guiding surface abuts the inclined guiding face.

The shank can be a polygon. The rear end of the connecting seat can include a polygonal hole. The front end of the shank is coupled in the polygonal hole of the connecting seat to permit joint rotation of the shank and the connecting seat.

The first recessed portion of the connecting seat can include a first opening and a first bottom wall opposite to the first opening. The first recessed portion can further include an inner wall having an abutment lip protruding therefrom. The abutment lip and the first opening define a displacement space for the button, and with the button covering the first opening.

The quick change woodworking spade bit can further include a cover having a hook portion on an inner side thereof. The second recessed portion of the connecting seat includes a second opening covered by the cover. The hook portion of the cover is coupled with the connecting portion of the actuating rod to permit joint movement of the cover and the actuating rod.

The engagement column of the actuating rod can include an engagement end. The button can include an inner side having a coupling groove coupled with the engagement end to permit joint movement of the button and the actuating rod.

The elastic element can be a compression spring mounted in the first recessed portion. The compression spring includes two ends abutting the button and the first bottom wall of the first recessed portion.

The present invention will become clearer in light of the following detailed description of illustrative embodiments of this invention described in connection with the drawings.

### DESCRIPTION OF THE DRAWINGS

FIG. 1 is an exploded, perspective view of a woodworking spade bit according to the present invention.

FIG. 2 is another exploded, perspective view of the woodworking spade bit according to the present invention.

FIG. 3 is a cross sectional view of the woodworking spade bit, with a bit being coupled to a connecting device of the woodworking spade bit.

FIG. 4 is a cross sectional view of the woodworking spade bit after assembly.

FIG. 5 is a perspective view of the woodworking spade bit.

FIG. 6 is a cross sectional view illustrating detachment of the bit from the connecting device of the woodworking spade bit.

FIG. 7 is a perspective view of a conventional woodworking spade bit.

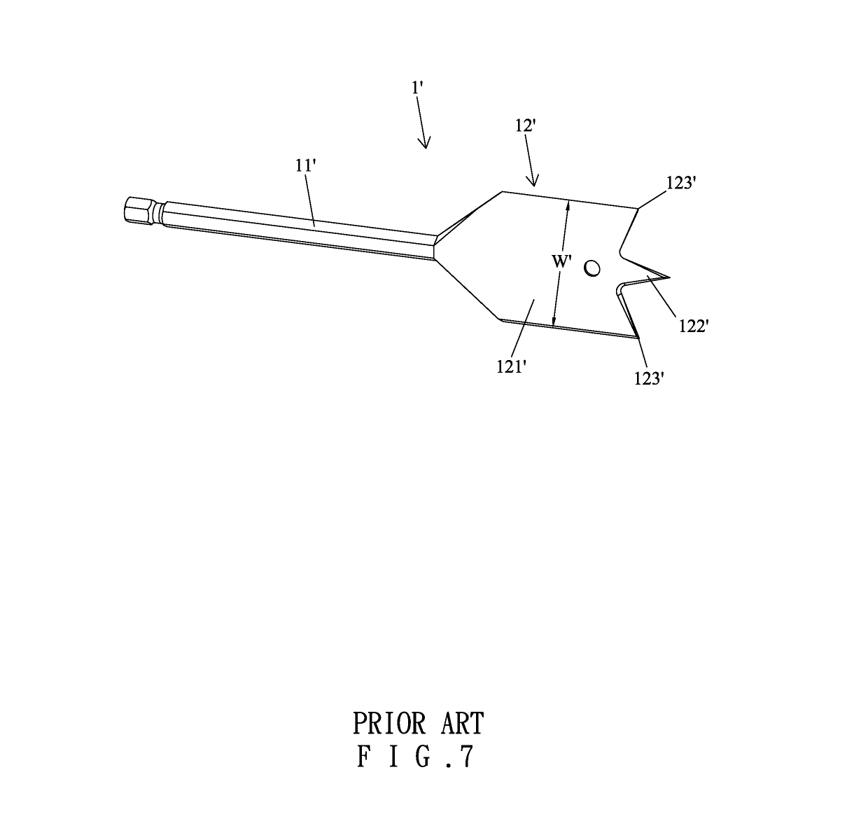

### DETAILED DESCRIPTION OF THE INVENTION

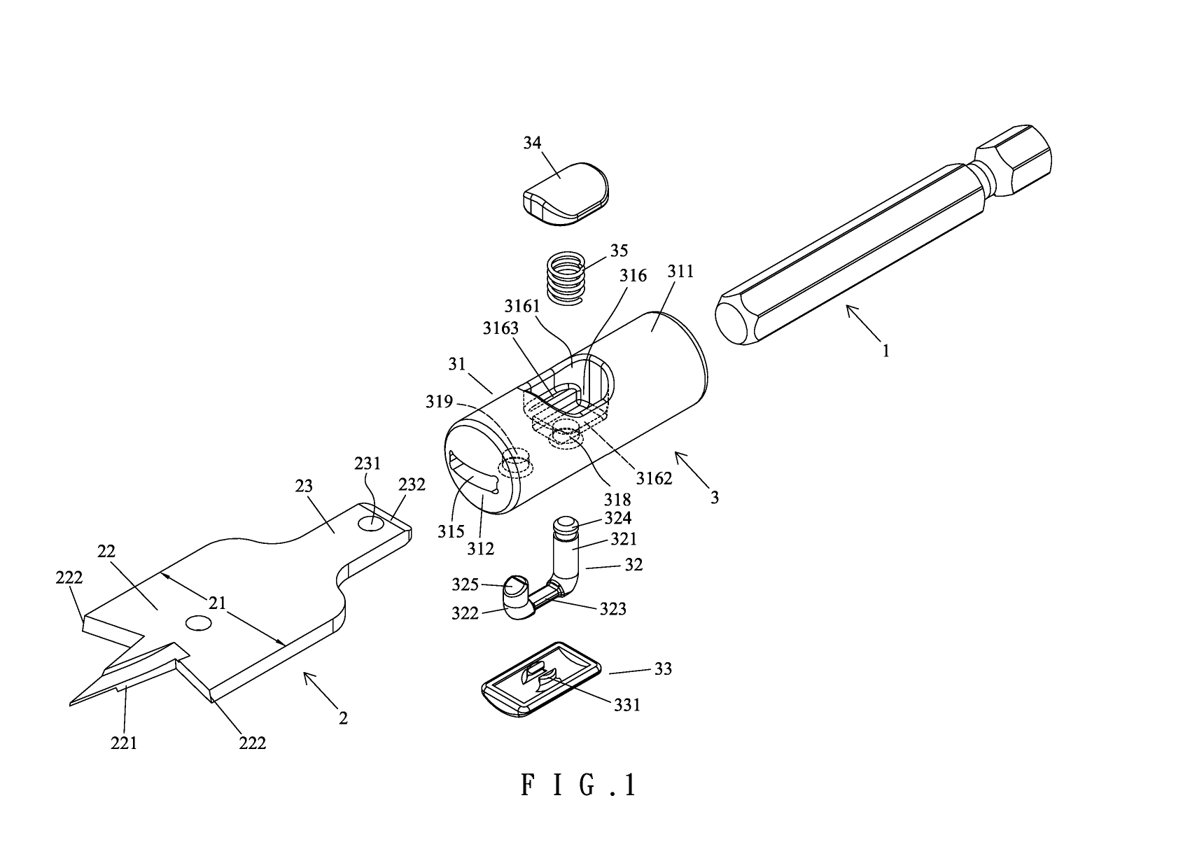

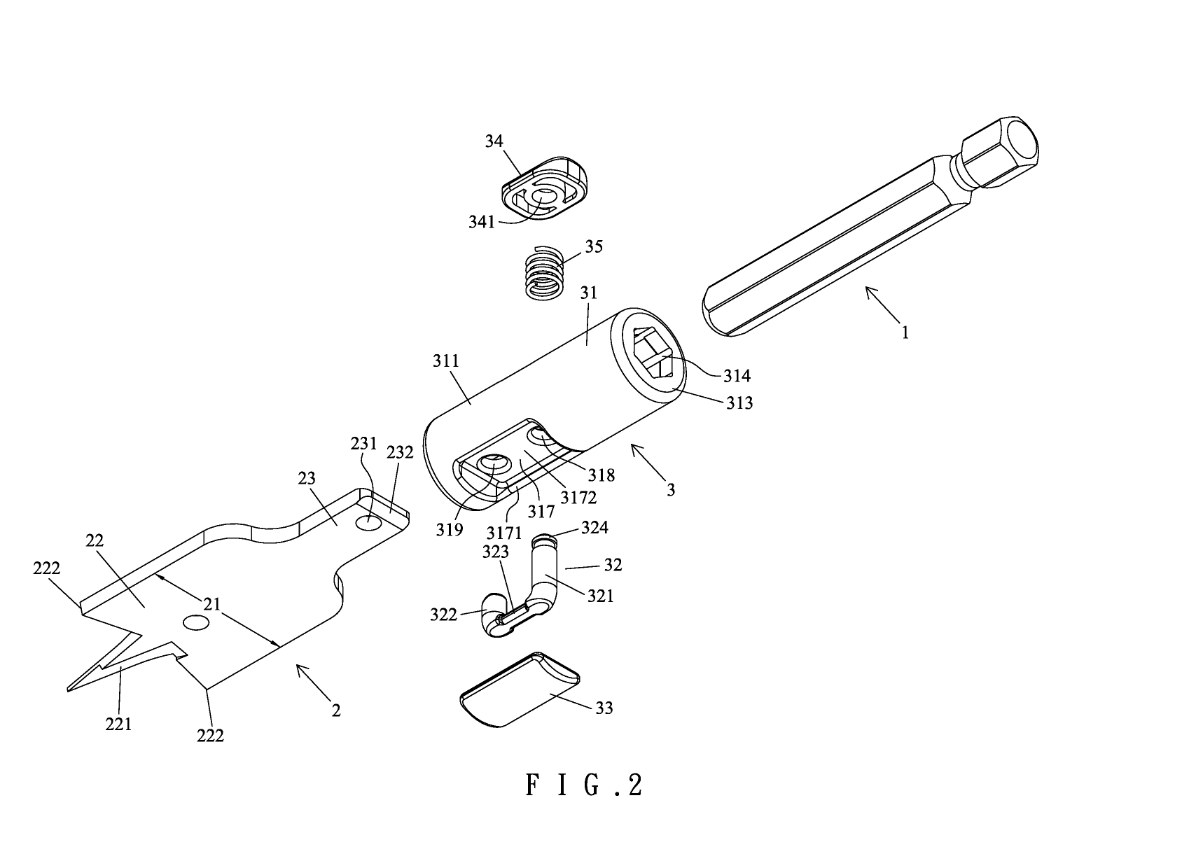

With reference to FIGS. 1-6, a quick change woodworking spade bit according to the present invention includes a shank 1, a bit 2, and a connecting device 3. The shank 1 is a polygon and has a rear end for coupling with an external tool (not shown). The bit 2 is a flat member and includes two wide faces 21 extending perpendicularly to a longitudinal direction and opposite to each other. The bit 2 further includes a front end having a cutting portion 22 and an insertion portion 23 spaced from the cutting portion 22 in the longitudinal direction. A guiding section 221 protrudes from a center of a front end of the cutting portion 22. A pointed portion 222 is provided on the front end of each of two sides of the cutting portion 22. A width of the insertion portion 23 is smaller than a width of the cutting portion 22. The insertion portion 23 includes a positioning hole 231 having a central axis extending perpendicularly to the two wide faces 21 and the longitudinal direction. The insertion portion 23 further includes a rear end having an inclined guiding face 232 inclining rearwards towards a central axis of the bit 2.

The connecting device 3 includes a connecting seat 31, an actuating rod 32, a cover 33, a button 34, and an elastic element 35. The connecting seat 31 is cylindrical and includes a front end 312, a rear end 313, and a peripheral wall 311 extending between the front and rear ends 312 and 313 of the connecting seat 31. The rear end 313 includes a rear coupling portion. In this example, the rear end 313 of the connecting seat 31 includes a polygonal hole 314 for coupling with the front end of the shank 1 to permit joint rotation of the shank 1 and the connecting seat 31. The connecting seat 31 further includes an insertion hole 315 extending from the front end 312 in the longitudinal direction. The insertion portion 23 of the bit 2 is detachably engaged in the insertion hole 315 of the connecting seat 31.

First and second recessed portions 316 and 317 are defined in an intermediate portion of the peripheral wall 311 of the connecting seat 31 and are diametrically opposite to each other. The first recessed portion 316 includes a first opening 3161 and a first bottom wall 3162 opposite to the first opening 3161. The first recessed portion 316 further includes an inner wall having an abutment lip 3163 protruding therefrom. The abutment lip 3163 and the first opening 3161 define a displacement space for the button 34 in a direction perpendicular to the longitudinal direction. The second recessed portion 317 includes a second opening 3171 and a second bottom wall 3172 opposite to the second opening 3171. The second bottom wall 3172 of the second recessed portion 317 includes a first through-hole 318 intercommunicated with the first recessed portion 316 and a second through-hole 319 intercommunicated with the insertion hole 315.

The actuating rod 32 is mounted in the second recessed portion 317 and includes an engagement column 321, a positioning column 322 and a connecting portion 323 interconnected between the engagement column 321 and the positioning column 322. The engagement column 321 extends through the first through-hole 318. The positioning column 322 extends through the second through-hole 319. The engagement column 321 of the actuating rod 32 includes an engagement end 324. The positioning column 322 includes an inclined guiding surface 325 inclining rearwards and upwards. The inclined guiding surface 325 abuts the inclined guiding face 232.

The cover 33 covers the second opening 3171 and includes a hooked portion 331 on an inner side thereof. The hook portion 331 of the cover 33 is coupled with the connecting portion 323 of the actuating rod 32 to permit joint movement of the cover 33 and the actuating rod 32.

The button 34 is mounted in the first recessed portion 316 to cover the first opening 3161 and is operably connected to the engagement column 321. In this example, the button 34 includes an inner side having a coupling groove 341 coupled with the engagement end 324 to permit joint movement of the button 34 and the actuating rod 32.

The elastic element 35 is mounted in the first recessed portion 316 to provide elasticity for operation of the button 34 and the actuating rod 32. In this example, the elastic element 35 is a compression spring and includes two ends abutting the inner side of the button 34 and the first bottom wall 3162 of the first recessed portion 316. The positioning column 322 is biased by the elastic element 35 to engage with the positioning hole 231.

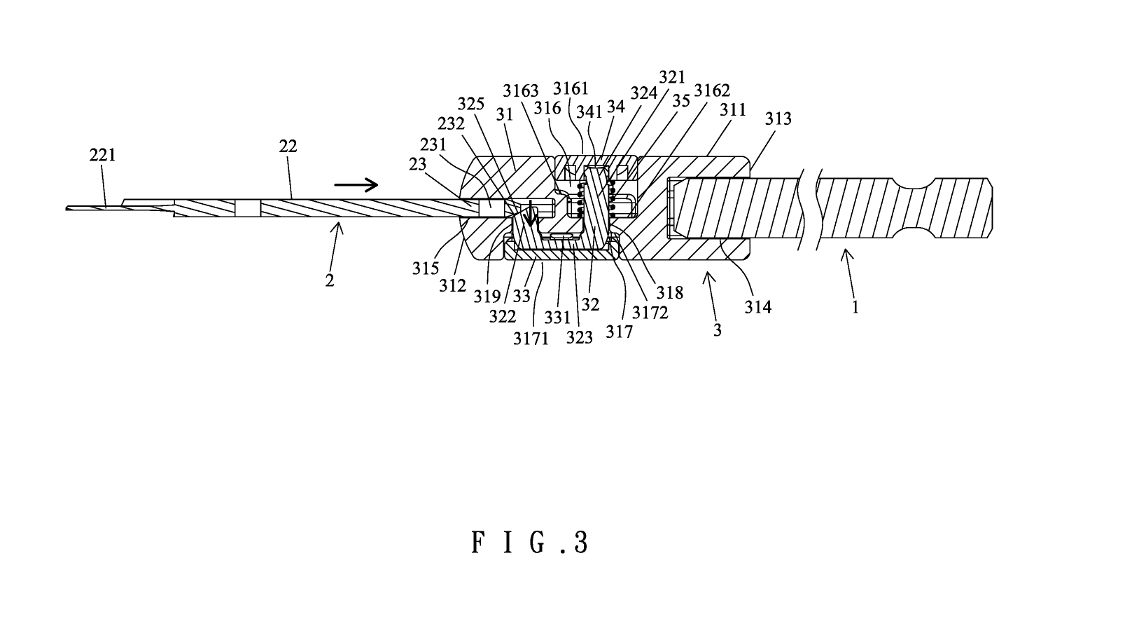

A bit 2 with a suitable shape and a suitable size according to need can be coupled with the connecting seat 31. In assembly, the insertion portion 23 of the bit 2 is inserted into the insertion hole 315 of the connecting seat 31. As shown in FIG. 3, the inclined guiding face 232 of the insertion portion 23 presses against the inclined guiding surface 325 of the positioning column 322, such that the positioning column 322 disengages from the insertion hole 315 in a radial direction perpendicular to the longitudinal direction and compresses the elastic element 35.

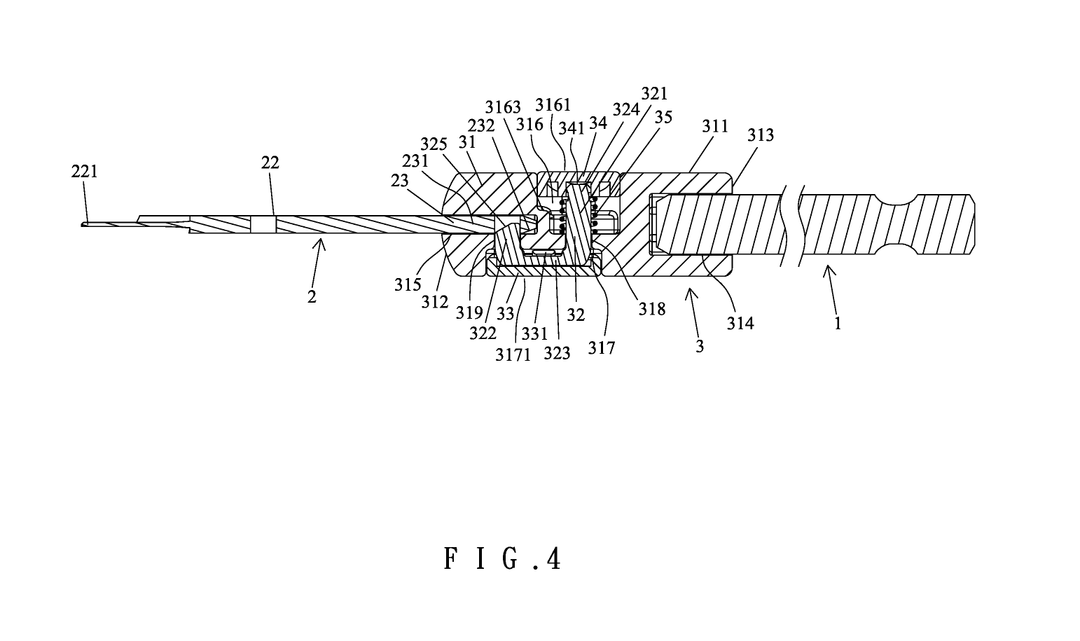

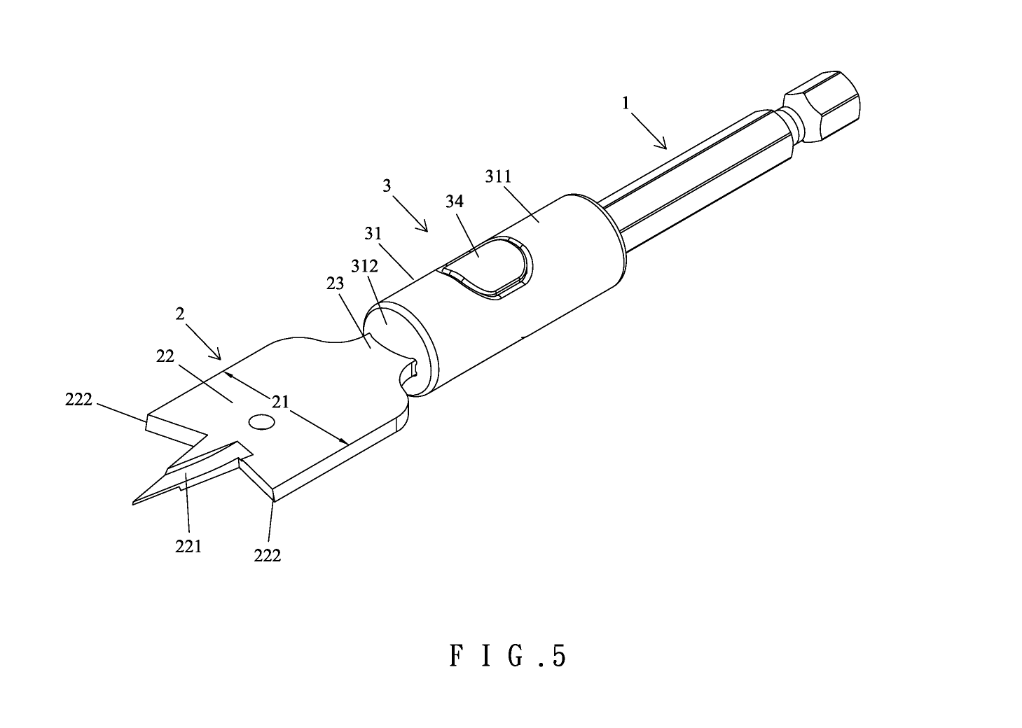

With reference to FIGS. 4 and 5, the insertion portion 23 is inserted further into the insertion hole 315 until the positioning hole 231 is aligned with the positioning column 322. In this case, the positioning column 322 is moved by the elastic force of the elastic element 35 into the positioning hole 231 to position the bit 2 on the connecting seat 31. The button 34 and the cover 33 respectively cover the first and second openings 3161 and 3171 to provide a sense of quality after assembly. The shank 1 is coupled with the polygonal hole 314 of the connecting seat 31 and is connected to the external tool for proceeding with woodworking hole drilling operation.

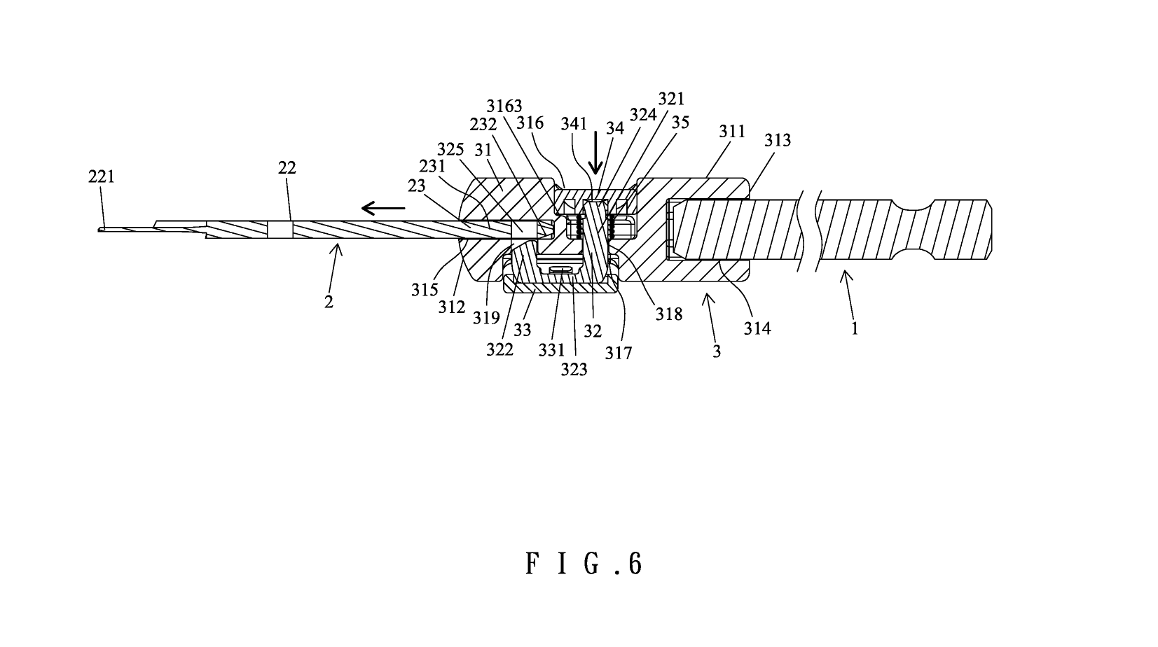

With reference to FIGS. 5 and 6, when it is desired to use a bit 2 of a different shape or a different size, the button 34 is pressed to move the engagement column 321 and the positioning column 322 in the radial direction and to disengage the positioning column 322 from the positioning hole 231. The abutment lip 3163 of the first recessed portion 316 restrains the depth travel of the button 34. The insertion portion 23 of the bit 2 can be detached from the insertion hole 315, and another bit 2 can be assembled. The replacement is easy. The bit 2 will not fly outwards from the front end when the button 34 is pressed, preventing a body of a user from being injured by the guiding section 221 and the pointed portions 222. Thus, the operation safety is provided.

Thus, the woodworking tool spade bit according to the present invention can reduce the inventory while eliminating the need of carrying many spade bits when going outside. Furthermore, when the bit 2 is worn out, it is not necessary to replace the whole spade bit, which is eco-friendly and reduces the replacement costs. Furthermore, the bit 2 can be made of a material more rigid than the shank 1.

Although specific embodiments have been illustrated and described, numerous modifications and variations are still possible without departing from the scope of the invention. The scope of the invention is limited by the accompanying claims.

1. A quick change woodworking spade bit comprising:
a shank including a front end;
a bit including two wide faces extending perpendicularly to a longitudinal direction and opposite to each other, with the bit including a front end having a cutting portion and an insertion portion spaced from the cutting portion in the longitudinal direction, and with the insertion portion including a positioning hole having a central axis extending perpendicularly to the two wide faces and the longitudinal direction; and
a connecting device including a connecting seat, an actuating rod, a button, and an elastic element, with the connecting seat including a front end, a rear end, and a peripheral wall extending between the front and rear ends of the connecting seat, with the rear end including a rear coupling portion, with the front end of the shank coupled with the rear coupling portion, with the connecting seat further including an insertion hole extending from the front end of the connecting seat in the longitudinal direction, with the insertion portion of the bit detachably engaged in the insertion hole of the connecting seat, with first and second recessed portions defined in an intermediate portion of the peripheral wall of the connecting seat and diametrically opposite to each other, with the second recessed portion including a first through-hole intercommunicated with the first recessed portion, with the second recessed portion further including a second through-hole intercommunicated with the insertion hole, with the actuating rod mounted in the second recessed portion and including an engagement column, a positioning column and a connecting portion interconnected between the engagement column and the positioning column, with the engagement column extending through the first through-hole, with the positioning column extending through the second through-hole, with the button mounted in the first recessed portion and operably connected to the engagement column, with the elastic element providing elasticity for operation of the button and the actuating rod, and with the positioning column biased by the elastic element to engage with the positioning hole, wherein when the button is pressed, the positioning column disengages from the positioning hole.

2. The quick change woodworking spade bit as claimed in claim 1, with the insertion portion of the bit including a rear end having an inclined guiding face inclining rearwards towards a central axis of the bit, with the positioning column including an inclined guiding surface inclining rearwards and upwards, and with the inclined guiding surface abutting the inclined guiding face.

3. The quick change woodworking spade bit as claimed in claim 1, with the shank being a polygon, with the rear end of the connecting seat including a polygonal hole, with the front end of the shank coupled in the polygonal hole of the connecting seat to permit joint rotation of the shank and the connecting seat.

4. The quick change woodworking spade bit as claimed in claim 1, with the first recessed portion of the connecting seat including a first opening and a first bottom wall opposite to the first opening, with the first recessed portion further including an inner wall having an abutment lip protruding therefrom, with the abutment lip and the first opening defining a displacement space for the button, and with the button covering the first opening.

5. The quick change woodworking spade bit as claimed in claim 1, further comprising a cover including a hook portion on an inner side thereof, with the second recessed portion of the connecting seat including a second opening, with the cover covering the second opening, with the hook portion of the cover coupled with the connecting portion of the actuating rod to permit joint movement of the cover and the actuating rod.

6. The quick change woodworking spade bit as claimed in claim 1, with the engagement column of the actuating rod including an engagement end, and with the button including an inner side having a coupling groove coupled with the engagement end to permit joint movement of the button and the actuating rod.

7. The quick change woodworking spade bit as claimed in claim 4, with the elastic element being a compression spring mounted in the first recessed portion, and with the compression spring including two ends abutting the button and the first bottom wall of the first recessed portion.
